(19) United States
(12) Patent Application Publication
(10) Pub. No.: US 2009/0265931 A1
(43) Pub. Date: Oct. 29, 2009

(54) METHOD FOR MANUFACTURING PROTECTIVE COVER FOR PREVENTION OF ELECTROMAGNETISM INTERFERENCE

(76) Inventor: Yu-Jen Cheng, Taipei City (TW)

Correspondence Address: HDLS Patent & Trademark Services, P.O. BOX 220746, CHANTILLY, VA, 20153-0746, US

(21) Appl. No.: 12/110,429

(22) Filed: Apr. 28, 2008

(51) Int. Cl. H01B 19/00

(52) U.S. Cl. 29/887

(57) ABSTRACT

A method for manufacturing a protective cover for prevention of electromagnetism interference includes the steps of: providing a die and a plastic board; press molding the plastic board using the die to manufacture a base plate, an enclosure plate, and at least a separator thereon, thereby obtain a shell of the protective cover to be manufactured; forming a metal cladding layer on a surface of the shell.

### BACKGROUND

The present invention relates to protective covers, and particularly to a method for manufacturing a protective cover for prevention of electromagnetism interference.

Most of communication products are high frequency products. Electronic components inside of these communication products are easy to produce electromagnetic waves. Particularly, in these communication products, some electronic components or modules mounted on a printed circuit board may generate interferential electromagnetic waves, thereby affecting a quality of signal transmission. In order to overcome the problem of electromagnetism interference, a shield is disposed around the electronic components or modules to prevent the electromagnetism interference from happen between electronic components and/or modules.

A conventional method for manufacturing a shield configuration for prevention electromagnetism interference is described in the following. A printed circuit board having a number electronic components mounted thereon is provided. A number of metal covers function as shields and are applied to each of the electronic components separately. Specifically, a solder paste is applied to a portion of copper circuits of the printed circuit board. An end surface of each of the metal covers is aligned with and mounted on the corresponding copper circuits and the solder past applied to the copper circuits, thereby obtaining a combination configuration of the printed circuit board and the metal covers (i.e. the shield configuration). Then, the combination configuration is placed in a reflow soldering furnace, thus the metal covers and the printed circuit board are welded together using the solder paste, thereby accomplishing the assembly of the metal covers and the printed circuit board, that is, accomplishing the manufacture of the shield configuration.

However, in practical application, the above-mentioned conventional method for manufacture of the shield configuration has following problems. Because each of the metal covers is mounted on the printed circuit board one by one, massive manpower is need to perform the aligning and mounting processes. In addition, because the metal covers and the printed circuit board are combined together using the soldering manner, once issues/errors occur in the assembly process, the combination configuration of the printed circuit board and the metal covers can not be detached, as a result, the combination configuration having the issues/errors must be discarded and be thrown away, thereby causing waste of materials and increasing cost of the manufacture of the shield configuration. Furthermore, the metal covers have a relative high cost of materials, and the combination configuration of the printed circuit board and the metal covers has a heavy structure, which is not concordance with the development trends of lightness of the communication products.

### BRIEF SUMMARY

The present invention mainly provides a method for manufacturing a protective cover which has a function for prevention of electromagnetism interference. In the present method, a number of isolation areas are directly molded together with the manufacture of a shell of the protective cover, thereby preventing the electromagnetism interference from happening between modules in different isolation areas.

Furthermore, in the present method for manufacturing a protective cover, the shell of the protective cover has an integrated structure, thus can shorten process and lower the manufacture cost.

Moreover, in the present method for manufacturing a protective cover, the shell of the protective cover is made of a plastic material, thus can lighten a weight of the protective cover and facilitate the manufacture of the protective cover.

In addition, the present method for manufacturing a protective cover, the shell of the protective cover is combined with a main body of a communication product using positioning components such as bolts, and an electrically conductive adhesive is applied therebetween, thus, overcomes an unevenness of an interface of the shell and the main body of a communication product. Also, the protective cover and the main body of a communication product can be detached and used repeatedly.

An embodiment of a method for manufacturing a protective cover includes steps of: providing a die and a plastic board; press molding the plastic board using the die to manufacture a base plate, an enclosure plate, and at least a separator thereon, thereby obtain a shell of the protective cover to be manufactured; forming a metal cladding layer on a surface of the shell.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a flow chart for manufacturing a protective cover, in accordance with a preferable embodiment.

FIG. 2 shows a cutaway view of a plastic board being disposed in a die, in accordance with the preferable embodiment.

FIG. 3 shows a cutaway view of the plastic board being pressed molded by the die, in accordance with the preferable embodiment.

FIG. 4 shows a cutaway view of a shell being cut in accordance with the preferable embodiment

FIG. 5 shows a three-dimensional view of the manufactured shell in accordance with the preferable embodiment.

FIG. 6 shows a three-dimensional view of the manufactured protective cover in accordance with the preferable embodiment.

FIG. 7 shows an exploded view of the protective cover and a main body of a mobile phone, in accordance with the preferable embodiment.

FIG. 8 shows an assembly view of the protective cover and the main body of the mobile phone, in accordance with the preferable embodiment.

FIG. 9 shows a cutaway view of FIG. 8 along the line 9-9.

### DETAILED DESCRIPTION

Embodiments will be described in detail below and with reference to the drawings.

A protective cover for prevention of electromagnetism interference to be manufactured includes a shell 1, a metal cladding layer 20. The shell 1 is made of plastic material.

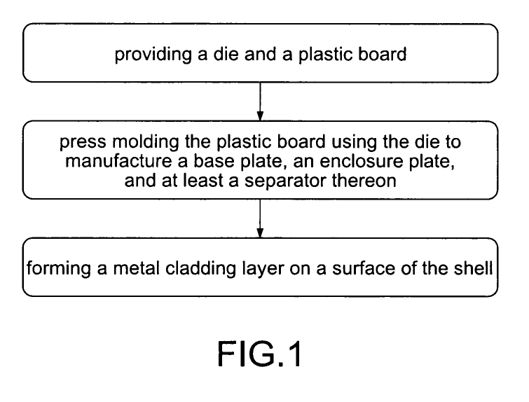

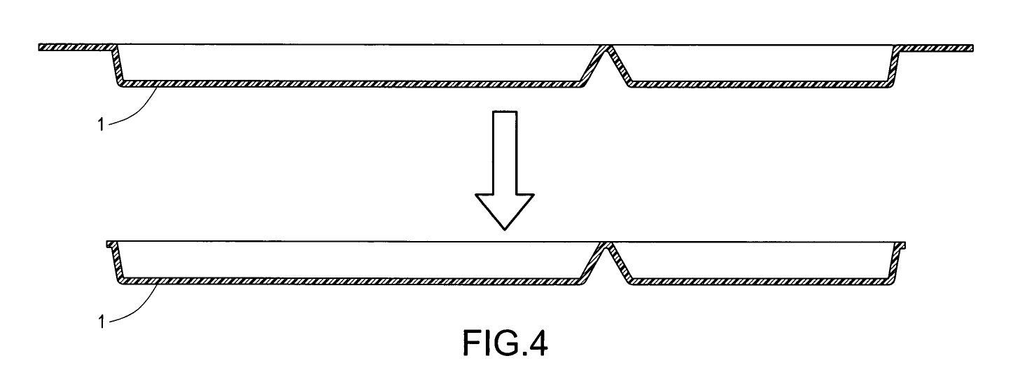

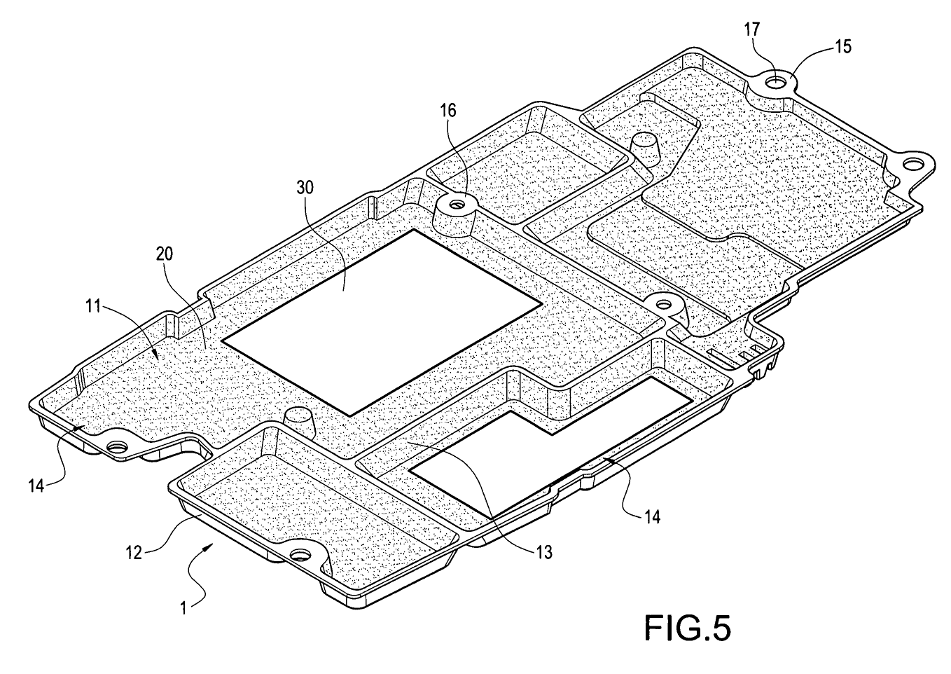

Referring to FIGS. 1-6, a method for manufacturing the protective cover includes the following steps.

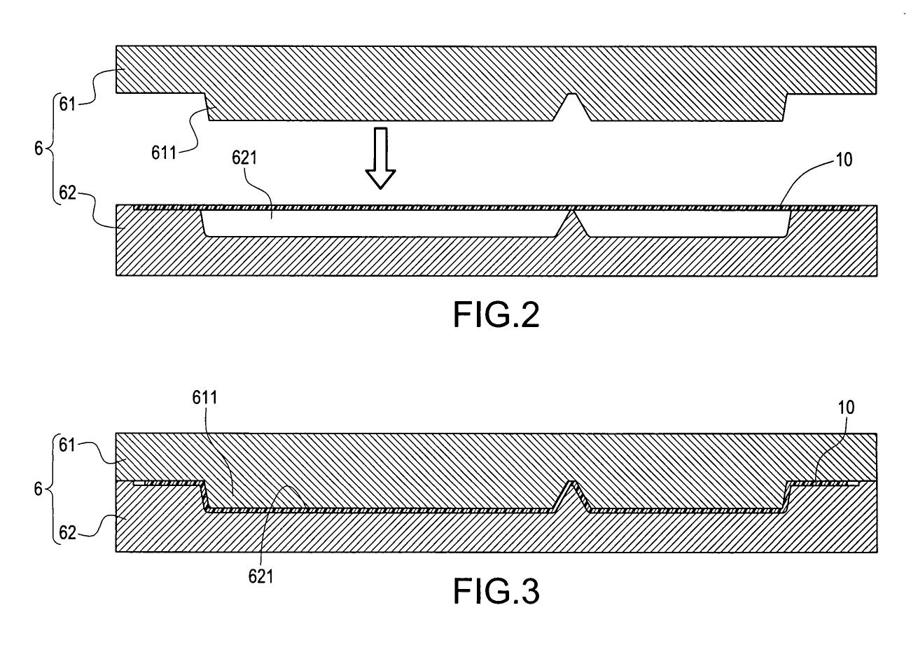

In a first step, a die 6 is provided, as shown in FIG. 2. The die 6 includes an upper die 61 and a lower die 62. In an operation of the die 6, the upper die 61 and the lower die 62 are arranged oppositely with each other. The upper die 61 has a bottom surface, and the lower die 62 has a top surface opposite to the bottom surface of the upper die 61. A concave structure 621 is opened in the lower die 62 from the top surface thereof. A convex structure 611 corresponding to the concave structure 621 extends or protrudes from the bottom surface of the upper die 61. In use, the upper die 61 and the lower die 62 are separately fixed on a press machine (not shown).

In a second step, a plastic board 10 is pressed by the die 6, and a base plate 11, an enclosure plate 12, and a separator 13 are formed on the plastic board 10, thereby the plastic board 10 being made into the shell 1. The plastic board 10 can be made of a material selected from a group consisting of polystyrene (PS), polycarbonate (PC), acrylonitrile-butadiene-styrene (ABS), prepreg (PP), Polyethylene Terephthalate (PET), polytetrafluoroethylene (PEEK), polytetrafluoroethylene (PTFE) and polyimide (PI). In this step, firstly, the plastic board 10 is disposed in the lower die 62. Secondly, the upper die 61 and the lower die 62 are heated, and the upper die 61 is controlled by the press machine to move towards the lower die 62. Thirdly, the upper die 61 continues to move towards the lower die 62, and the convex structure 611 of the upper die 61 presses the plastic board 10 into the concave structure 621 of the lower die 62, as shown in FIG. 3. After this pressing process, referring to FIG. 5, the plastic board 10 has the base plate 11 formed thereon. An edge of the base plate 11 bends upwardly and forms the enclosure plate 12 surrounding the base plate 11. The base plate 11 inside of the enclosure plate 12 disposes a number of separators 13, and a height of each separator 13 is identical with that of the enclosure plate 12. The separators 13, the base plate 11 and the enclosure plate 12 cooperatively define a number of closed isolation areas 14 without communicating with each other. Thus, the base plate 11 and the enclosure plate 12, the separators 13, and the isolation areas 14 together constitute the shell 1 of the protective cover to be manufactured. In addition, at least a cylindrical column 16 is form on some separators 13.

In a third step, the shell 1 obtained in the second step is machined (e.g., cutting, stamping holes, etc.) using a tool. An outer edge of a top surface of the enclosure plate 12 of the shell 1 processed in the second step may be concave-convex (i.e., not smooth). A cutting tool can be used to cut or smooth the outer edge of the top surface of the enclosure plate 12, and a number of ledges 15 are formed at the edge of the top surface of the enclosure plate 12, simultaneously. In addition, in the above cutting or smoothing process, a number of fixing holes 17 are stamped in a center of each of the ledges 15 and cylindrical columns 16.

In a fourth step, a metal cladding layer 20 is coated on a surface of the shell 1, as shown in FIG. 5. The metal cladding layer 20 can be formed on the surface of the shell 1 using a chemical deposition method or a physical deposition method. The physical deposition method includes a sputter method, evaporation method, and so on. In the present embodiment, the metal cladding layer 20 is sputtered on outer surfaces and/or inner surfaces of the base plate 11, the enclosure plate 12, and the separators 13.

In a fifth step, a shielding pad 30 is adhered to the inner surface of the shell 1, as shown in FIG. 5. The shielding pad 30 can be an insulator such as an adhesive tape. Each of the isolation areas 14 defines a base plate area in the base plate 11, and the shielding pad 30 is adhered to and shields each of the base plate areas of the base plate 11. This step (i.e., the fifth step) can be performed before or after the above-described fourth step. In the present embodiment, the fifth step is performed after the above-described fourth step. With respect to this step, due to the application of the shielding pad 30, the concave configuration of the base plate 11 can be eliminated. Furthermore, a short circuit phenomena can not happen between electronic components (not shown) mounted on the base plate 11 inside of each of the isolation areas 14 and the corresponding base plate 11, due to the presence of the shielding pad 30.

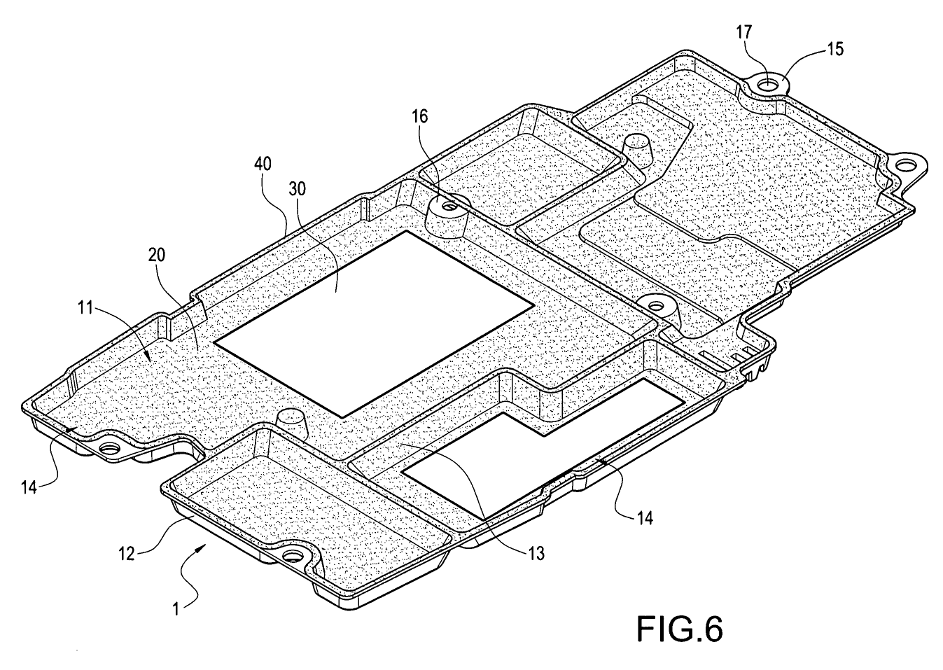

In a sixth step, an electrically conductive adhesive 40 is applied to the top surface of the enclosure plate 12 and the separators 13, as shown in FIG. 6. The electrically conductive adhesive 40 can be formed on such top surface using a screen printing method, a curtain coating method, a spraying method, a heat pressing method, or a gluing method. In sum, the above-described six steps complete the manufacture of the protective cover.

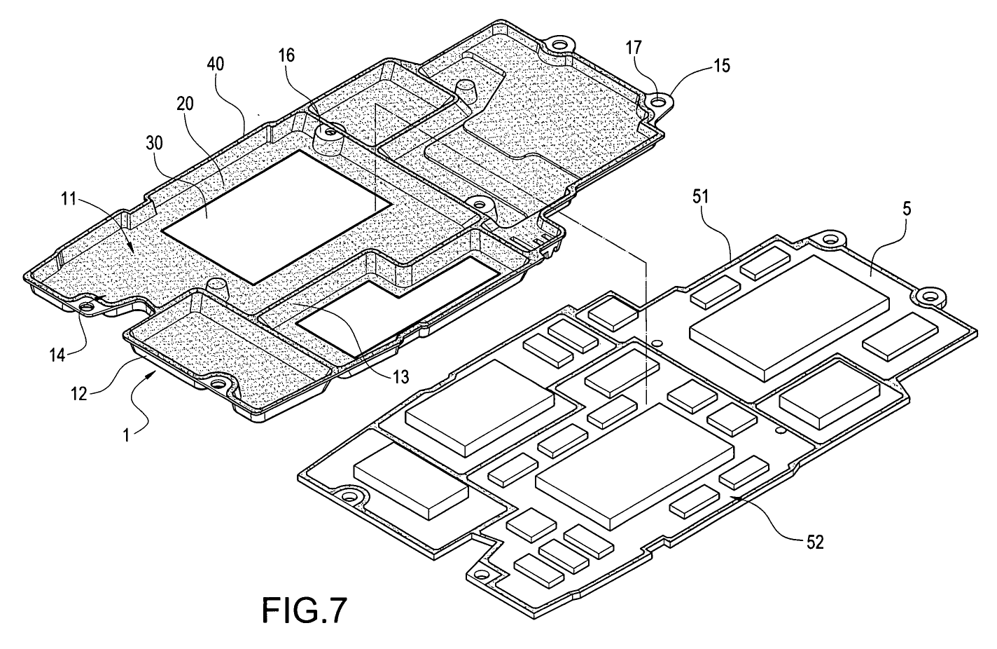

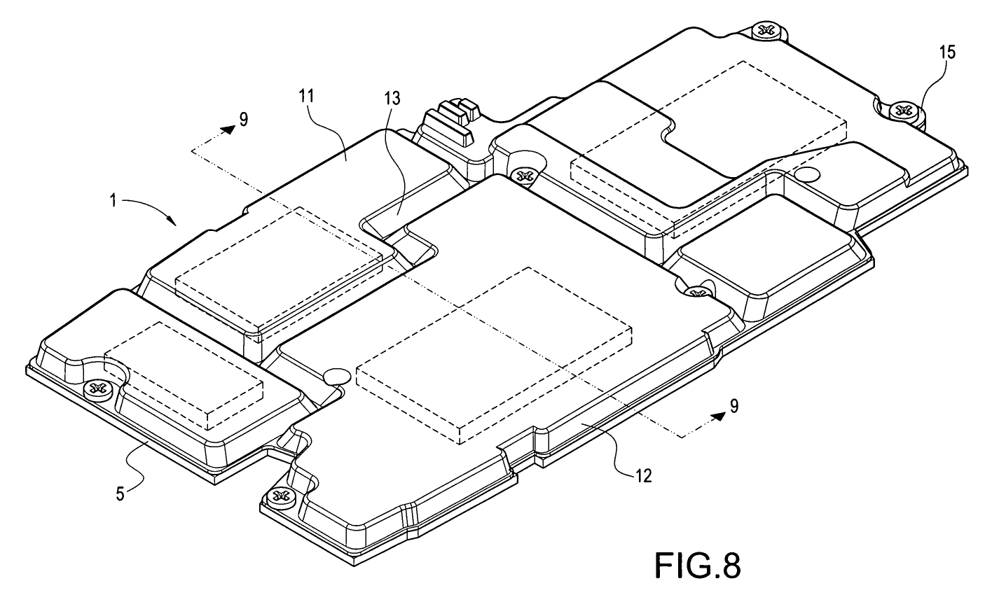

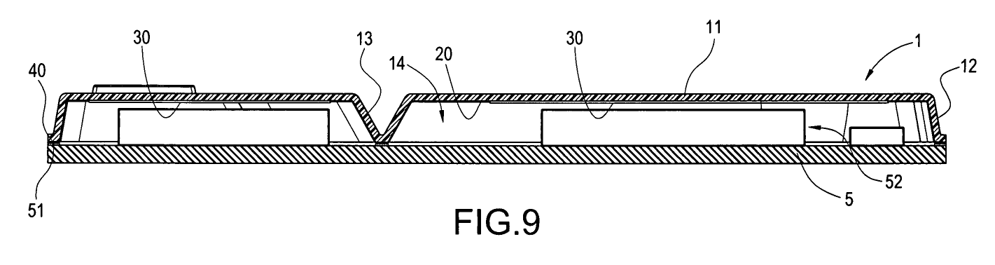

Referring to FIGS. 7 to 9, the protective cover can be applied to communication products. For example, the protective cover is applied to a main body 5 of a mobile phone. An enclosure copper circuit 51 is formed on a surface of the main body 5, and a configuration of the copper circuit 51 corresponds to that of the enclosure plate 12. A number of wireless modules 52 are disposed on the surface of the main body 5. Each of the wireless modules 52 is composed of at least one electronic component. In a process of assembling the protective cover and the main body 5, the plastic board 10 (i.e., the shell 1) is placed on the main body 5, and the copper circuit 51 contacts and combines with the enclosure plate 12 by the electrically conductive adhesive 40. Then, the protective cover is fixed on the main body 5 using positioning components such as bolts passing through the corresponding fixing holes 17 and being fixed on the main body 5. Thus, the protective cover and the main body 5 are combined together tightly, thereby an effect of prevention of electromagnetism interference of the protective cover is greatly improved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for manufacturing a protective cover for prevention of electromagnetism interference, the method comprising the steps of:
providing a die and a plastic board;
press molding the plastic board using the die to manufacture a base plate, an enclosure plate, and at least a separator thereon, thereby obtain a shell of the protective cover to be manufactured;
forming a metal cladding layer on a surface of the shell.

2. The method as claimed in claim 1, wherein the provided die comprises an upper die and a lower die, the lower die defines a concave structure, and a bottom surface of the upper die defines a convex structure corresponding to the concave structure.

3. The method as claimed in claim 1, wherein the plastic board is heated and pressed by the die in the press molding step.

4. The method as claimed in claim 1, in the press molding step, the plastic board is made of a material selected from a group consisting of PS, PC, ABS, PP, PET, PEEK, PTFE and PI.

5. The method as claimed in claim 1, in the press molding step, manufacturing a closed enclosure plate on the plastic board.

6. The method as claimed in claim 1, in the press molding step, a height of the manufactured separator is identical with a height of the enclosure plate.

7. The method as claimed in claim 1, in the press molding step, the base plate, the enclosure plate and the separator cooperatively define a plurality of isolation areas without communicating with each other.

8. The method as claimed in claim 1, in the press molding step, additionally forming at least a cylindrical column in the separator.

9. The method as claimed in claim 1, in the press molding step, additionally comprising a step of cutting the shell and/or stamping holes in the shell using a tool.

10. The method as claimed in claim 9, after the step of cutting the shell and/or stamping holes in the shell, comprising a step of adhering a shielding pad to an inner surface of the shell.

11. The method as claimed in claim 10, in the step of adhering the shielding pad to the inner surface of the shell, comprising a step of adhering an insulation shielding pad to a surface of the base plate.

12. The method as claimed in claim 1, wherein employing a sputter deposition method forming the metal cladding layer on the surface of the shell.

13. The method as claimed in claim 12, wherein depositing the metal cladding layer on an inner surface of the base plate, the enclosure plate and the separator.

14. The method as claimed in claim 12, wherein depositing the metal cladding layer on an outer surface of the base plate, the enclosure plate and the separator.

15. The method as claimed in claim 1, after the step of forming the metal cladding layer on the surface of the shell, comprising a step of adhering a shielding pad to an inner surface of the shell.

16. The method as claimed in claim 15, in the step of adhering a shielding pad to an inner surface of the shell, adhering an insulation shielding pad to a surface of the base plate.

17. The method as claimed in claim 1, after the step of forming the metal cladding layer on the surface of the shell, comprising a step of forming an electrically conductive adhesive on top surfaces of the enclosure plate and the separator.

18. The method as claimed in claim 17, wherein employing a screen printing method, a curtain coating method, a spraying method, a heat pressing method, or a gluing method to form the electrically conductive adhesive on top surfaces of the enclosure plate and the separator.
